(19) United States
(12) Patent Application Publication
(10) Pub. No.: US 2025/0154808 A1
(43) Pub. Date: May 15, 2025

(54) American-Style Hinge

(71) Applicant: Jieyang Tianyi Hardware Products Co., Ltd, Guangdong (CN)

(72) Inventors: Wujie TANG, Guangdong (CN); Quan LI, Guangdong (CN)

(73) Assignee: Jieyang Tianyi Hardware Products Co., Ltd, Guangdong (CN)

(21) Appl. No.: 19/026,084

(22) Filed: Jan. 16, 2025

(30) Foreign Application Priority Data
Aug. 29, 2024 (CN) 202411194935.8

(51) Int. Cl. E05D 3/02; E05D 11/00

(52) U.S. Cl. CPC E05D 3/02; E05D 11/00

(57) ABSTRACT

The present disclosure provides an American-style hinge, which comprises a hinge plate and an installation member capable of rotating relative to the hinge plate, wherein a working groove is provided in the hinge plate, an inner assembly plate is disposed in the working groove, and a plurality of hinge cups are disposed in the inner assembly plate; the hinge cup is provided with a connecting spring, a limit post is inserted into the connecting spring, and the limit post passes through the other end of the connecting spring and is fixedly connected with a second rectangular plate.

### CROSS-REFERENCE TO RELATED APPLICATIONS

This application claims the priority of China Patent Application No. 2024111949358 filed on Aug. 29, 2024, entitled “American-style Hinge”, all the contents and amendments of which are incorporated into this application by reference.

### TECHNICAL FIELD

The present disclosure relates to the technical field of hinges, particularly to an American-style hinge.

### BACKGROUND

American-style hinges are common hinges for doors, windows or furniture. American-style hinges are often used in doors and windows, cupboard doors and other connecting parts in the fields of family, commerce and industrial buildings, and are an important part of home building materials such as doors and windows. American-style hinges are widely used, especially in cabinets where in-line cabinets are used as corner cabinets and some cabinets are used as fixed sealing plates.

The existing U.S. Pat. No. 9,163,447 discloses a “Hinge with damping device”, which realizes buffering and resetting by a torsion spring. However, when the hinge is used, the torsion spring is in direct contact with the hinge, which will cause friction during use, thus reducing the durability of the hinge and affecting its service life.

Therefore, there is a need to propose a new type of American-style hinge to solve the above problems.

### SUMMARY

The present disclosure provides an American-style hinge to solve the problems mentioned in the background art.

In order to achieve the object of the present disclosure, the present disclosure adopts the following technical solution:

An American-style hinge includes a hinge plate and an installation member capable of rotating relative to the hinge plate, wherein the hinge plate is provided with a working groove inside, an inner assembly plate is disposed in the working groove, and a plurality of hinge cups are disposed inside the inner assembly plate; and the hinge cup is provided with a connecting spring, a limit post is inserted into the connecting spring, and the limit post passes through the other end of the connecting spring and is fixedly connected with a second rectangular plate; and a working hole is disposed in the middle of two adjacent hinge cups, a buffer mechanism is disposed in the working hole, a first rectangular plate is disposed at a side of the buffer mechanism, and the buffer mechanism is connected with the first rectangular plate.

The present disclosure further provides an American-style hinge, which includes a hinge plate and an installation member capable of rotating relative to the hinge plate, wherein the hinge plate is provided with a working groove inside, an inner assembly plate is disposed in the working groove, a plurality of hinge cups are disposed in the inner assembly plate, and elastic members are disposed in the hinge cups; and a connector is disposed between the installation member and the hinge plate, and at least one end of the connector is rotatably disposed in the working groove and abuts against the elastic members.

### BRIEF DESCRIPTION OF DRAWINGS

The drawings, which constitute a part of this application, are used to provide a further understanding of the present disclosure. The illustrative embodiments of the present disclosure and the descriptions thereof are used to explain the present disclosure, and do not constitute undue limitations on the present disclosure. In the drawings:

FIG. 1 is a schematic diagram of an American-style hinge structure of the present disclosure;

FIG. 2 is an internal schematic diagram of the American-style hinge structure in the present disclosure;

FIG. 3 is a schematic diagram of the internal structure of the hinge plate in the present disclosure;

FIG. 4 is a schematic structural diagram of the inner assembly plate in the present disclosure;

FIG. 5 is a schematic structural diagram of the arc-shaped connecting plate in the present disclosure;

FIG. 6 is an exploded view of the American-style hinge assembly in the present disclosure;

FIG. 7 is a cross-sectional view of the inner assembly plate according to the present disclosure.

Reference signs: Hinge plate (1); Upper connecting plate (2); Inner assembly plate (3); First rectangular plate (4); squeezing arc plate (5); Connecting shaft (6); Arc-shaped connecting plate (7); First fixing bolt (8); Connecting slot (9); Lower assembly plate (10); Second fixing bolt (11); Upper assembly plate (12); Connecting clamping plate (13); Limit post (14); Buffer mechanism (15); Connecting spring (16); Second rectangular plate (17); Working groove (18); Side clamping plate (19); Hinge cup (20); Working hole (21); Rotation shaft ring plate (22); Compression spring (23); Rectangular side plate (24); Middle assembly plate (25).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

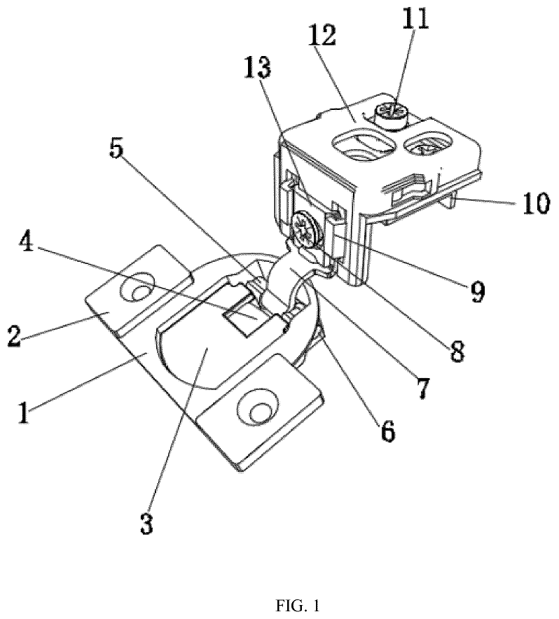

As shown in FIG. 1-FIG. 7, an American-style hinge includes a hinge plate 1 and an installation member that can rotate relative to the hinge plate 1. A working groove 18 is provided in the hinge plate 1, an inner assembly plate 3 is provided in the working groove 18, and hinge cups 20 are provided in the inner assembly plate 3. The hinge cups 20 are provided with elastic members. The elastic member is a connecting spring 16, a limit post 14 is inserted into the connecting spring 16, and the limit post 14 passes through the other end of the connecting spring 16 and is fixedly connected with a second rectangular plate 17. A working hole 21 is disposed in the middle of two adjacent hinge cups 20, and a buffer mechanism 15 is disposed in the working hole 21. A first rectangular plate 4 is disposed on one side of the buffer mechanism 15, and the buffer mechanism 15 is connected with a first rectangular plate 4.

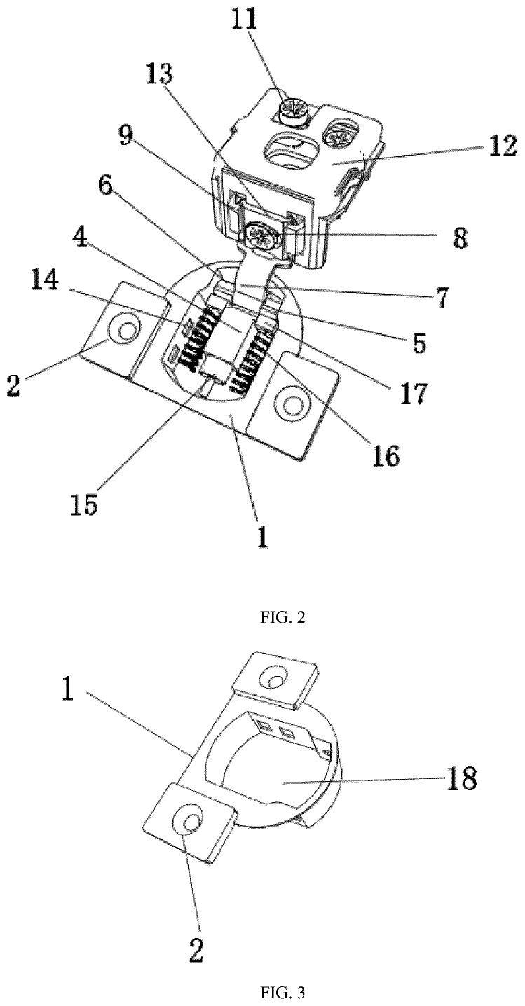

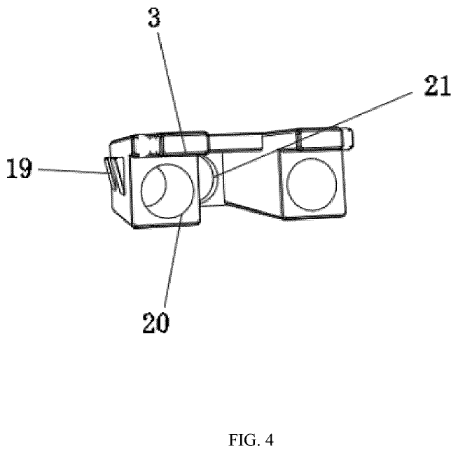

Please refer to FIG. 2, FIG. 3 and FIG. 7, in this embodiment, a rectangular groove is provided in the inner assembly plate 3, and a compression spring 23 is disposed in the rectangular groove. There is no specific limitation on the number of the compression spring 23, and it can be one or more. The other end of the compression spring 23 is fixedly connected with a side clamping plate 19, and the side clamping plate 19 can slide in the rectangular groove through the compression spring 23. When the compression spring 23 is not compressed, at least a part of the end of the side clamping plate 19 far away from the compression spring 23 protrudes from the rectangular groove, and the end protruding from the rectangular groove is provided with a guide surface. The guide surface optimizes the contact angle by the setting of an inclined surface, which reduces the hard friction between the side clamping plate 19 and the working groove 18 and makes the installation smoother.

The working groove 18 is provided with clamping grooves, and the number of clamping grooves is not specifically limited. In this embodiment, the number of clamping grooves is four, and the numbers of rectangular grooves and side clamping plates 19 corresponds to the number of clamping grooves. When the inner assembly plate 3 is installed, the inner assembly plate 3 is placed on the working groove 18, and the side clamping plate 19 is pressed, so that the side clamping plate 19 is squeezed by the inner wall of the working groove 18 and slides into the rectangular groove, and the compression spring 23 is squeezed. When the inner assembly plate 3 reaches a preset position, the side clamping plate 19 faces the clamping groove, penetrates through the rectangular groove and is inserted into the clamping groove under the action of the compression spring 23. The dimensions of the clamping groove and the side clamping plate 19 are matched, so that the inner assembly plate 3 is tightly clamped and firmly connected with the working groove 18. When disassembly is needed, the inner assembly plate 3 can be taken out of the working groove 18 by pressing one end of the side clamping plate 19 penetrating through the rectangular groove. This structural design enhances the stability of the hinge and ensures its smooth operation under high load.

In other embodiments (not shown), the elastic member and the compression spring can also be replaced by other elastic members, such as elastic telescopic rod, spring leaf, rubber pad and magnetic rebound, etc. Appropriate elastic members can be selected according to specific application scenarios and requirements to realize the reset function.

In other embodiments (not shown), the inner assembly plate 3 and the working groove 18 can be connected by means of screws, snap-fastening and magnetic connection. Different connection modes can be selected according to the actual needs and design requirements of the product.

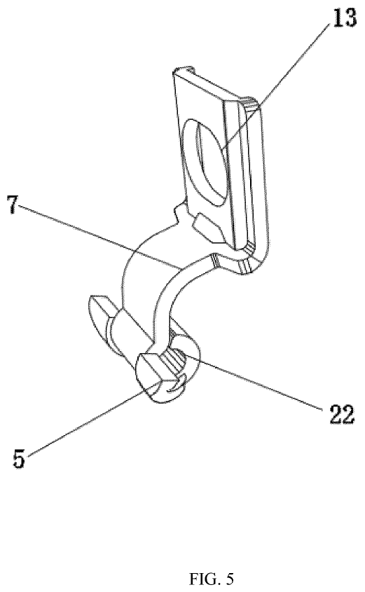

As shown in FIG. 2 and FIG. 5, in this embodiment, the hinge plate 1 is made of hard and corrosion-resistant metal, such as stainless steel and alloy steel, which not only ensures the strength and durability of the hinge, but also endows it with good corrosion resistance to adapt to various complex and harsh use environments.

Please refer to FIG. 1, FIG. 2, FIG. 5 and FIG. 7, in this embodiment, the working groove 18 is further provided with a rotation shaft ring plate 22 close to the inner assembly plate 3, and two squeezing arc plates 5 are fixedly connected to the side surface of the rotation shaft ring plate 22, and the squeezing arc plates 5 abut against the second rectangular plate 17. The inside of the rotation shaft ring plate 22 is provided with a connecting shaft 6, the working groove 18 is provided with a through hole, and the connecting shaft 6 is inserted into the through hole and rotatably connected with the through hole, so that the rotation shaft ring plate 22 can rotate around the connecting shaft 6 in the working groove 18 within a certain range of angles. The upper end of the rotation shaft ring plate 22 is fixedly connected with an arc-shaped connecting plate 7, and the upper end of the arc-shaped connecting plate 7 is fixedly connected with a connecting clamping plate 13.

When the rotation shaft ring plate 22 rotates around the connecting shaft 6, it drives the squeezing arc plate 5 to rotate, and the squeezing arc plate 5 begins to squeeze the second rectangular plate 17 to compress the connecting spring 16. The connecting spring 16 has a certain elastic resistance, which is used to provide feedback resistance to control the rotating speed and strength of the rotation shaft ring plate 22 and the squeezing arc plate 5. The elasticity of the connecting spring 16 is also used to assist the second rectangular plate 17 in returning to its original position after the squeezing arc plate 5 releases the pressure on the second rectangular plate 17.

In another embodiment (not shown), the squeezing arc plate 5 has certain elasticity, and when the squeezing arc plate 5 squeezes the second rectangular plate 17, the squeezing arc plate 5 will undergo certain elastic deformation to play a buffering role.

In other embodiments (not shown), the rotation shaft ring plate 22 can be configured to be connected to the shaft 6, and an installation seat is disposed at the corresponding position of the working groove 18. The rotation shaft ring plate 22 is installed in the installation seat. The rotation shaft ring plate 22 can rotate in the installation seat within a certain range of angles to realize the rotary connection. The rotation shaft ring plate 22 and the working groove 18 can also be rotatably connected by means of bearing connection, gear connection and the like.

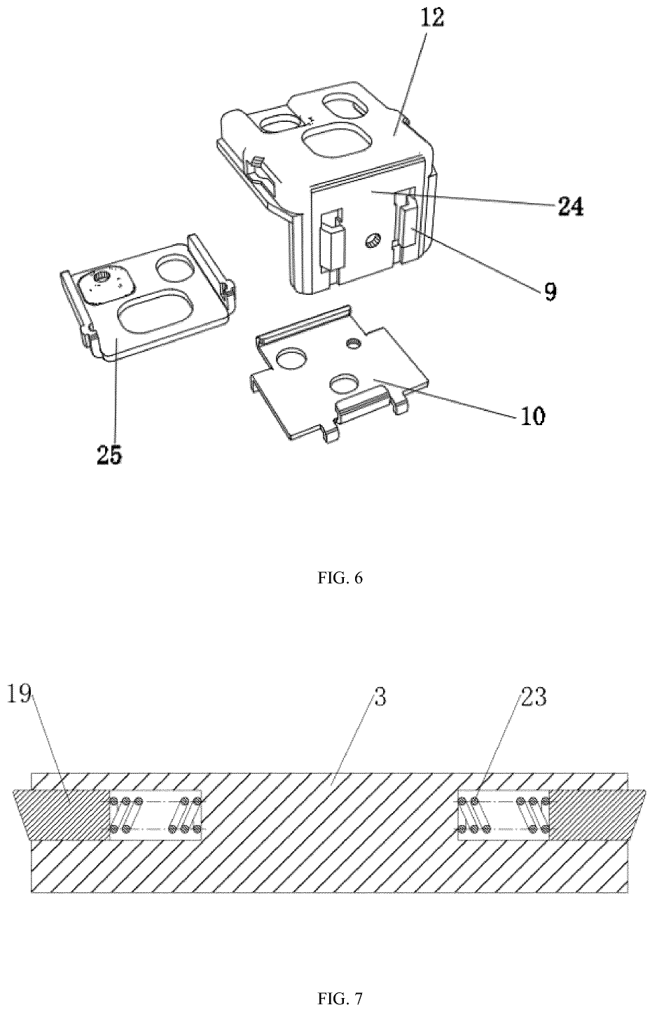

Please refer to FIG. 1, FIG. 5 and FIG. 6, in this embodiment, the installation member includes a connecting slot 9, and the connecting clamping plate 13 is clamped inside the connecting slot 9. The installation member further includes a rectangular side plate 24 and an upper assembly plate 12. The connecting slot 9 is fixedly connected to the rectangular side plate 24, and the connecting clamping plate 13 is threadedly connected with a first fixing bolt 8. The first fixing bolt 8 is inserted between the connecting clamping plate 13 and the rectangular side plate 24. During installation, the connecting clamp plate 13 is inserted along the connecting slot 9 to reach a preset position, and then the connecting clamp plate 13 and the rectangular side plate 24 are screwed and fixed by the first fixing bolt 8 to prevent loosening and falling off during use.

In another embodiment (not shown), the connecting slot 9 can be cancelled, and two first fixing bolts 8 are used. The bolt through holes on the connecting clamping plate 13 are designed as oval through holes, so that the position between the connecting clamping plate 13 and the rectangular side plate 24 can be adjusted to a certain extent, and the hinge has wider applicability and stronger adaptability.

Please refer to FIG. 1, FIG. 2 and FIG. 6, in this embodiment, one side of the rectangular side plate 24 facing away from the connecting clamping plate 13 is fixedly connected with the upper assembly plate 12. The lower end of the upper assembly plate 12 is provided with a middle assembly plate 25 and a lower assembly plate 10. Second fixing bolts 11 are inserted between the upper assembly plate 12, the middle assembly plate 25 and the lower assembly plate 10, and the upper assembly plate 12, the middle assembly plate 25 and the lower assembly plate 10 are screwed and fixed by the second fixing bolts 11, so that the upper assembly plate 12, the middle assembly plate 25 and the lower assembly plate 10 have detachable functions. During usage, the second fixing bolts 11 are screwed up to prevent it from loosening or falling off during use.

Please refer to FIG. 1 to FIG. 3, in this embodiment, the upper end of the hinge plate 1 is provided with two upper connecting plates 2, which are used to fix the hinge plate 1 on the door. The upper connecting plates 2 are provided with screw through holes, and the shape of the screw through holes may be round or oval.

Please refer to FIG. 2, in this embodiment, the buffer mechanism 15 is a hydraulic damper. The hydraulic damper enables the hinge to slowly close itself in the process of opening and closing through the hydraulic buffering technology, thus effectively reducing the impact force and avoiding noise. Even in the case of forced opening and closing, the hydraulic damping hinge can ensure the door to close gently, realize silent opening and closing, and improve the use experience.

In other embodiments (not shown), the buffer mechanism 15 may also be damping spring buffer, pneumatic buffer, rubber buffer and other buffer mechanisms 15, and an appropriate buffer mechanism 15 can be selected according to actual use requirements.

In another embodiment (not shown), an American-style hinge includes a hinge plate 1, and an installation member capable of rotating relative to the hinge plate 1. A working groove 18 is provided in the hinge plate 1, and an inner assembly plate 3 is disposed in the working groove 18. Two hinge cups 20 are disposed in the inner assembly plate 3, and connecting springs 16 are disposed in the hinge cups 20. A connector is disposed between the installation member and the hinge plate 1, and at least one end of the connector is rotatably disposed in the working groove 18 and abuts against the connecting spring 16. The difference between this embodiment and the above-mentioned embodiment is that the hinge need not be provided with the working hole 21 and the buffer structure, so that the production process of the hinge is simpler and more efficient, the production efficiency is improved and the production cost is reduced, thus further increasing the market competitiveness of the product, which is adapted for some occasions with low requirements on the buffer effect.

In conclusion, from the above description, it can be seen that the present disclosure has the following technical effects: the hinge is opened and closed by providing the connecting spring 16 in the hinge, so that the phenomenon of hard abrasion between parts and the spring is solved, and the service life of the hinge is prolonged; the connecting spring 16 can absorb and store the energy generated in the opening and closing process, the impact and wear on the hinge caused by strong opening and closing are reduced, and the service life of the hinge is prolonged; when the hinge is running, the elastic resistance generated when the connecting spring 16 is squeezed makes the hinge open and close more smoothly, and the hydraulic damper is also disposed in the hinge, which makes the hinge more quiet and gentle when it is opened and closed, and improves the quality of the hinge and the user experience.

In the description of the present disclosure, it should be appreciated that the orientation or positional relationship indicated by orientation words such as “front, back, upper, lower, left, right”, “lateral, vertical, horizontal” and “top, bottom” are usually based on the orientation or positional relationship shown in the attached drawings, just for the convenience of describing the present disclosure and simplifying the description. Unless otherwise stated, these orientation words do not indicate or imply that the device or element referred to must have a specific orientation or be constructed and operated in a specific orientation, therefore they cannot be construed as limiting the scope of protection of the present disclosure. The orientation words “inside and outside” refer to the inside and outside relative to the outline of each component itself.

For the convenience of description, spatially relative terms such as “above”, “on”, “on the upper surface of” and “upper” can be used here to describe the spatial positional relationship between a device or feature as shown in the drawings and other devices or features. It should be appreciated that spatially relative terms are intended to encompass different orientations in use or operation in addition to the orientation of the device depicted in the drawings. For example, if the devices in the drawings are inverted, devices described as “above” or “on” other devices or structures will be positioned as “below” or “under” other devices or structures. Thus, the exemplary term “above” can include both orientation of “above” and “below”. The device can also be positioned in other different ways (rotated by 90 degrees or in other orientations), and the spatial relative description used here is explained accordingly.

In addition, it should be noted that the words “first” and “second” are used to define parts for the convenience of distinguishing the corresponding parts. Unless otherwise stated, the above words have no special meaning, and thus they cannot be construed as limiting the protection scope of the present disclosure.

What has been described above is only the preferred embodiment of the present disclosure, and it is not intended to limit the present disclosure. For those skilled in the art, the present disclosure may have various modifications and changes. Any modification, equivalent substitution, improvement and the like made within the spirit and principle of the present disclosure shall fall into the protection scope of the present disclosure.

What is claimed is:

1. An American-style hinge, comprising a hinge plate and an installation member capable of rotating relative to the hinge plate, wherein
the hinge plate is provided with a working groove inside, an inner assembly plate is disposed in the working groove, and a plurality of hinge cups are disposed inside the inner assembly plate; and
the hinge cup is provided with a connecting spring, a limit post is inserted into the connecting spring, and the limit post passes through the other end of the connecting spring and is fixedly connected with a second rectangular plate; and
a working hole is disposed in the middle of two adjacent hinge cups, a buffer mechanism is disposed in the working hole, a first rectangular plate is disposed at a side of the buffer mechanism, and the buffer mechanism is connected with the first rectangular plate.

2. The American-style hinge according to claim 1, wherein a rectangular groove is provided in the inner assembly plate, a plurality of compression springs are disposed in the rectangular groove, and the other ends of the compression springs are fixedly connected with side clamping plates.

3. The American-style hinge according to claim 2, wherein the working groove is provided with a plurality of clamping grooves, the side clamping plates penetrate through the rectangular groove and are inserted into the clamping grooves, and the dimensions of the clamping grooves are matched with those of the side clamping plates.

4. The American-style hinge according to claim 1, wherein the hinge plate is made of hard and corrosion-resistant metal.

5. The American-style hinge according to claim 1, wherein the working groove is further provided with a rotation shaft ring plate close to the inner assembly plate, a plurality of squeezing arc plates are fixedly connected to a side surface of the rotation shaft ring plate, and the squeezing arc plates abut against the second rectangular plate.

6. The American-style hinge according to claim 5, wherein a connecting shaft is disposed inside the rotation shaft ring plate, a through hole is provided in the working groove, and the connecting shaft is inserted into the through hole and rotatably connected with the through hole.

7. The American-style hinge according to claim 5, wherein an upper end of the rotation shaft ring plate is fixedly connected with an arc-shaped connecting plate, and an upper end of the arc-shaped connecting plate is fixedly connected with a connecting clamping plate.

8. The American-style hinge according to claim 7, wherein the installation member comprises a connecting slot, and the connecting clamping plate is clamped in the connecting slot.

9. The American-style hinge according to claim 8, wherein the installation member further comprises a rectangular side plate and an upper assembly plate, and the connecting slot is fixedly connected to the rectangular side plate.

10. The American-style hinge according to claim 9, wherein the connecting clamp plate is connected with a first fixing bolt in a threaded way, and the first fixing bolt is inserted between the connecting clamp plate and the rectangular side plate.

11. The American-style hinge according to claim 10, wherein a side of the rectangular side plate facing away from the connecting clamping plate is fixedly connected with the upper assembly plate; and
wherein a lower end of the upper assembly plate is provided with a middle assembly plate and a lower assembly plate.

12. The American-style hinge according to claim 11, wherein second fixing bolts are inserted between the upper assembly plate, the middle assembly plate and the lower assembly plate.

13. The American-style hinge according to claim 1, wherein a plurality of upper connecting plates are disposed at an upper end of the hinge plate.

14. An American-style hinge, comprising a hinge plate and an installation member capable of rotating relative to the hinge plate, wherein
the hinge plate is provided with a working groove inside, an inner assembly plate is disposed in the working groove, a plurality of hinge cups are disposed in the inner assembly plate, and elastic members are disposed in the hinge cups; and
a connector is disposed between the installation member and the hinge plate, and at least one end of the connector is rotatably disposed in the working groove and abuts against the elastic members.

15. The American-style hinge according to claim 14, wherein the elastic member is a connecting spring, and a limit post is inserted into the connecting spring, and the limit post passes through the other end of the connecting spring and is fixedly connected with a second rectangular plate.

16. The American-style hinge according to claim 15, wherein the connector is an arc-shaped connecting plate, one end of the arc-shaped connecting plate is fixedly connected with the installation member, while the other end extends into the working groove and is fixedly connected with a rotation shaft ring plate.

17. The American-style hinge according to claim 16, wherein a plurality of squeezing arc plates are fixedly connected to a side surface of the rotation shaft ring plate, and the squeezing arc plates abut against the second rectangular plate.

18. The American-style hinge according to claim 16, wherein a connecting shaft is disposed inside the rotation shaft ring plate, a through hole is provided in the working groove, and the connecting shaft is inserted into the through hole and rotatably connected with the through hole.

19. The American-style hinge according to claim 14, wherein a working hole is disposed in the middle of two adjacent hinge cups, a buffer mechanism is disposed in the working hole, and the buffer mechanism extends out of the working hole and abuts against the connector.

20. The American-style hinge according to claim 19, wherein the buffer mechanism is a hydraulic damper or a damping spring.
